(19) United States
(12) Patent Application Publication
(10) Pub. No.: US 2006/0225967 A1
(43) Pub. Date: Oct. 12, 2006

(54) Conical spring buffer for an elevator

(76) Inventor: Shusaku Shibasaki, Chiba-ken (JP)

Correspondence Address: Troxell K. Snyder;Otis Elevator Company, 10 Farm Springs, Farmington, CT, 06032, US

(21) Appl. No.: 10/521,539

(22) PCT Filed: Jun. 23, 2003
(86) PCT No.: PCT/US03/19856

§ 371 Date: Jan. 14, 2005

(30) Foreign Application Priority Data
Jul. 16, 2002 (JP) 2002-206866

(51) Int. Cl. B66B 5/28

(52) U.S. Cl. 187/343

(57) ABSTRACT

A spring buffer (26) for an elevator car (12) includes a conical spring coil (32).

### FIELD OF THE INVENTION

The present invention relates to a spring buffer for an elevator car operating in a vertical hoistway.

### BACKGROUND

The use of the decelerating buffers placed at the extreme limit of travel of an elevator car or counterweight are known in the art. Typically such buffers are made of helical springs or hydraulic dampers which are disposed in the elevator pit at the lower end of the hoistway. In the event the elevator car should travel beyond its normal range, the car will encounter the buffer which in turn brings the car to a stop in a controlled fashion prior to contacting the hoistway floor.

In a traction drive elevator arrangement wherein the elevator car and a counterweight are connected by one or more ropes move within the hoistway, it is also common to provide the counterweight with a similar buffer at the extreme lower limit of its travel range. Thus, the passenger car will be limited in travel in both the upward and downward directions with the system, encountering the respective buffer which provides a controlled stop in the event of an overrun. The requirements for a spring buffer during operation are generally defined by local elevator codes in the respective markets. The codes generally set travel requirements, deceleration rate, and load rating.

In order to achieve the desired deceleration rate, the buffer must experience sufficient compression travel in order to absorb the energy of the descending car or counterweight at the required rate. Thus, for a helical spring buffer, the overall buffer uncompressed height is at least the sum of the required compression travel plus the height of the fully compressed spring. Since the spring buffer is located in the hoistway pit, uncompressed spring buffer height is a factor in the required pit depth. As will be appreciated by those skilled in the art, increased pit depth and size results in an increase in elevator system costs. What is needed is an improved spring buffer design which reduces required pit depth.

### DISCLOSURE OF THE INVENTION

According to the present invention, a buffer for an elevator car is provided with a spring member having the spring coils arranged in a conical spiral, wherein adjacent coils are sized so as to be received within the next larger coil as the spring is compressed. Thus, a conical spring buffer according to the present invention may achieve a sufficiently long stroke between its uncompressed and fully compressed states so as to decelerate the elevator car at the required rate while reducing the overall buffer uncompressed height.

According to a first embodiment of the present invention, a conical spring is disposed in the pit of an elevator hoistway. The spring is fashioned with a coil diameter gradually decreasing in the upward vertical direction such that the end of the spring with the smallest diameter is oriented vertically toward the descending elevator car or counterweight. Unlike a conventional helical coil spring wherein the coils are of equal diameter and stacked axially, the conical spring according to the present invention comprises successive coils which spiral radially inwardly such that each adjacent coil is disposed wholly within the diameter of the next outward coil.

By arranging the coils of the conical spring according to the present invention such that the successive coils are thus able to “nest”, the overall axial height of the fully compressed spring is small as compared to the axial uncompressed height. By selecting the proper material, element cross-section, and diameter, it is possible to achieve equivalent performance as compared to prior art helical spring buffers, but at a greatly reduced uncompressed height.

According to a second embodiment of the present invention, a conical spring as described above may additionally be configured so as to achieve a variable spring rate at different stages of compression, whereby the force imparted on the car or counterweight in the event of an overrun may vary in response to the contact force.

According to various other embodiments of the present invention, the spring coils may be fashioned of elements having circular, rectangular, or other cross-sections.

### BRIEF DESCRIPTION OF THE DRAWINGS

FIG. 1 shows a schematic cross-section of a traction elevator system as disposed in a typical hoistway.

FIG. 2 shows a side elevation of a conical spring buffer according to the present invention.

FIG. 3(A) shows a side elevation of an elevator car and a conical spring buffer according to the present invention.

FIG. 3(B) shows the car and buffer arrangement of FIG. 3 (A) as it would appear in the event of an overrun.

FIG. 4 shows the conical spring buffer according to the present invention in a counterweight buffering arrangement.

### BEST MODE FOR CARRYING OUT THE INVENTION

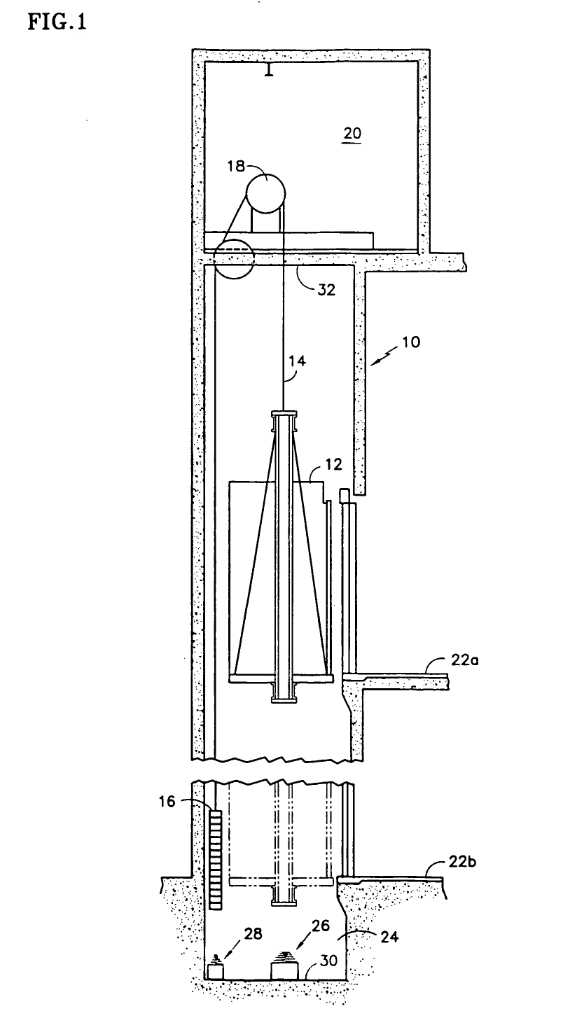

Referring now to the drawing figures, and in particular to FIG. 1, the spring buffer according to the present invention will now be described.

FIG. 1 shows a schematic of a typical elevator hoistway 10 for a traction arrangement, including an elevator car 12 suspended by one or more ropes 14 running between the car 12 and a vertically suspended counterweight 16. The ropes 14 pass over a traction sheave 18 driven by a machine (not shown) located in a machine room 20 typically disposed at the upper end of the hoistway 10.

During normal operation, the car 12 operates vertically within the hoistway 10 stopping at the desired floors 22 a, 22 b. As shown in FIG. 1, floor 22 a represents the uppermost floor served by the elevator car 12 and floor 22 b the lowest floor. The hoistway includes a pit area 24 in which are located one or more buffers 26, 28 according to the present invention.

In the event the elevator car 12 were to pass beyond its normal operating range, it will be appreciated by a review of FIG. 1 that it will inevitably contact either the floor 30 of the pit 24 or the ceiling 32 of the hoistway 10, damaging the elevator equipment as well as the surrounding building structure. There is also the potential for injury to any passengers who may be riding in the car. It is a function of buffers 26, 28 to absorb the momentum of the descending car or counterweight so as to decelerate each at a controlled rate, thereby reducing the effects of an overrun occurrence.

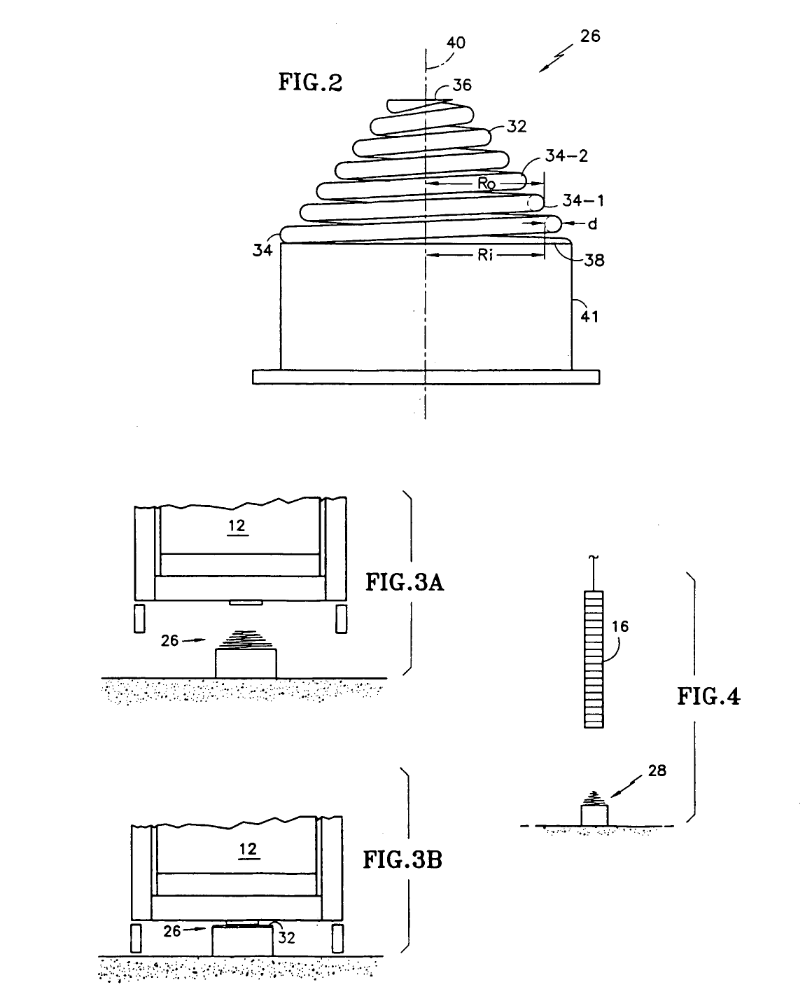

Referring now to FIG. 2, the conical spring buffer 26 is shown and described. The construction of the buffer 26 according to the present invention is essentially identical to that of the counterweight buffer 28.

As shown in FIG. 2, the buffer 26 includes a conical spring coil 32 having its largest or base coil 34 disposed at the lowermost end thereof, and spiraling inwardly and upwardly simultaneously in the vertical direction whereby successive coils 34-1, 34-2, etc. are sized such that the outer radius of the next inward coil is less than the inner radius of the preceding coil. In the example as shown, the outer radius Ro of coil 34-2 is less than the inner radius Ri of coil 34-1, thereby allowing coil 34-2 to pass radially inward of coil 34-1 when the spring is compressed axially.

As also shown in FIG. 2, the final coils of the conical spring 32 are flattened to provide surfaces 36, 38 which are perpendicular to the central axis 40. The flat surface 38 at the larger end of the conical spring 32 rests upon a cylindrical base 41 in the embodiment as shown in FIG. 2. The spring 32 should preferably be secured to the base by any of a number of equally equivalent means, including welding, bolting, gluing, etc. The base 41 in turn is fixed to the floor 30 of the hoistway 10 to prevent movement or dislocation during operation.

The radius of the coils 34, the diameter d of the coil element, the transverse pitch of the coils, and material type of the conical spring 32 are selected to provide the desired axial stroke and spring constant for the particular elevator application as required by the elevator code or other performance requirements. It should now be apparent that the overall length of the conical spring 32 according to the present invention is less than a prior art helical spring which must be sized not only to undergo the required axial deformation, but also has a considerably greater minimum length when fully compressed due to the axial stacking of the equal diameter spring coils.

FIG. 3(a) shows the spring buffer 26 according to the present invention arranged so as to contact the elevator car 12 in the event of an overrun at the lower end of the hoistway 10. As shown in FIG. 3 (b), the elevator 12 has passed beyond its normal operating range and entered the pit where it has contacted the conical spring 32 and compressed it fully.

FIG. 4 shows and equivalent buffer 28 adapted to contact the counterweight 16 in the event of a car overrun at the top of the hoistway 10. The construction of the counterweight buffer 28 according to the present invention is virtually identical to that of the car buffer 26, but sized as required for use with the counterweight. The operation of the counterweight buffer 28 is identical to that of the car buffer 26, except that the counterweight buffer prevents damage to the elevator car by stopping the counterweight at the lower end of the hoistway 10, thereby removing any upward force on the car 12 by means of the ropes 14.

It should be noted that although shown in terms of a constant pitch spring with a round diameter spring element, the conical spring according to the present invention may also be fabricated with a spring element having an oval or rectangular cross-section, and the coil pitch may vary over the length of the spring so as to provide a variable spring constant, depending on the degree of compression of the spring. Both these and other equivalent structures will be apparent to those skills in the art upon review of the foregoing specification and the appended claims and drawing figures.

1. A spring buffer for an elevator system, said buffer disposed at one end of a hoistway of the elevator system for contacting a vertically moving member of said elevator system in the event of an abnormal overrun,
characterized in that
said spring buffer includes a conical coil spring having a spiral coil element radius decreasing with increasing axial displacement.

2. A spring buffer as recited in claim 1, further characterized in that said conical coil spring comprises a series of coils, wherein the outer radius of the next sequential coil is less than the inner radius of the preceding coil, thereby permitting said coils to be compressed axially without experiencing radial interference.

3. The spring buffer as recited in claim 2, further characterized in that the cross-section of the coil element is circular.

4. The spring buffer as recited in claim 2, further characterized in that the cross-section of the coil element is rectangular.

5. The spring buffer as recited in claim 2, further characterized in that the transverse coil pitch is constant.

6. The spring buffer as recited in claim 1, where in the vertically moving element is an elevator car.

7. The spring buffer as recited in claim 1, where in the vertically moving element is a counterweight.
